(19) United States
(12) Patent Application Publication
(10) Pub. No.: US 2013/0212646 A1
(43) Pub. Date: Aug. 15, 2013

(54) Usage authentication via intercept and challege for network services

(71) Applicants: Keith A. McFarland, Annapolis, MD (US); Doug Kesser, Mooresville, NC (US); Victor Burton, Bellevue, WA (US); Baby Raman, Ellicott City, MD (US); Amar Sathyanarayanan, Gaithersburg, MD (US)

(72) Inventors: Keith A. McFarland, Annapolis, MD (US); Doug Kesser, Mooresville, NC (US); Victor Burton, Bellevue, WA (US); Baby Raman, Ellicott City, MD (US); Amar Sathyanarayanan, Gaithersburg, MD (US)

(21) Appl. No.: 13/506,418

(22) Filed: Apr. 18, 2012

Related U.S. Application Data
(60) Provisional application No. 61/457,871, filed on Jun. 24, 2011.

(51) Int. Cl. H04L 29/06

(52) U.S. Cl. CPC H04L 63/08
USPC 726/4

(57) ABSTRACT

A security broker (SB) that provides network based authorization of secure VoIP services, triggered upon attempted user access. The security broker (SB) intercepts a SIP transaction during session setup to transmit a network based security challenge to a SIP application attempting to access (secure) IP based services. A network based security challenge is transmitted to a participating SIP application on both the origination and termination legs of a SIP transaction. The network based security challenge prompts a SIP application to return subscriber authorization/authentication credentials (e.g. a username/password combination). If credentials returned by the SIP application are valid, the security broker (SB) authorizes the network to permit session completion, and access to secure IP services is granted. Alternatively, if credentials returned by the VoIP application are invalid, the security broker (SB) terminates the corresponding session attempt, hence preventing unauthorized access to (secure) IP based services.

The present application claims priority from U.S. Provisional No. 61/457,871, entitled “Usage Authentication via Intercept and Challenge for Network Services”, to McFarland et al., filed Jun. 24, 2011; the entirety of which is explicitly incorporated herein by reference.

### BACKGROUND OF THE INVENTION

1. Field of the Invention

This invention relates generally to telecommunications. More particularly, it relates to the network-based security of Session Initiated Protocol (SIP) services indiscriminate to wireless, fixed or landline applications.

2. Background of the Related Art

Internet Telephony conjoins voice and data networks to route live, streaming multimedia sessions (e.g. voice and/or video sessions) over an Internet Protocol (IP) network (e.g. the Internet). Voice over Internet Protocol (VoIP) is an exemplary Internet Telephony protocol that conveys voice and video information over an IP network via the digitization and reconstruction of analog voice signals.

FIG. 4 portrays a conventional transmission of voice information over an Internet Protocol (IP) network using Voice over Internet Protocol (VoIP). A traditional voice signal is initially recorded in analog format. As depicted in step 400, Voice over Internet Protocol (VoIP) begins by converting an analog voice signal to digital format, i.e. data, for packetization and transmission over an Internet Protocol (IP) network (e.g. the Internet). As shown in step 410, Voice over Internet Protocol (VoIP) routes digital voice information to a designated destination device in real time (i.e. via Real Time Protocol), to permit live voice communication amongst participating VoIP devices. As depicted in step 420, transmitted voice information is eventually received on an intended destination device, where digital voice signals are reassembled and converted back to analog voice signals for audio playback.

IP Multimedia Subsystem (IMS) is an architecture that supports VoIP services. A Call Session Control Function (CSCF) and a Breakout Gateway Control Function (BGCF) are two exemplary IP Multimedia Subsystem (IMS) components utilized in Voice over Internet Protocol (VoIP).

A Call Session Control Function (CSCF) orchestrates the registry and authentication of a device requesting VoIP services. Moreover, the Call Session Control Function (CSCF) initiates session control features, and routes media content between an originating and destination VoIP device.

A Breakout Gateway Control Function (BGCF) is used in conjunction with Voice over Internet Protocol (VoIP) to transfer a VoIP call from a packet-based data network to a traditional Public Switched Telephone Network (PSTN).

Voice over Internet Protocol (VoIP) incorporates session control features to set up and tear down VoIP calls. Session Initiation Protocol (SIP), for instance, is an exemplary signaling protocol used to facilitate session control throughout a VoIP call.

The Session Initiation Protocol (SIP) or Secure Session Initiated Protocol (SIPS) manages IP based services by transmitting SIP/S request and response messages between communicating VoIP devices. For instance, SIP INVITE is an exemplary SIP request message, transmitted to invite a destination device to engage in a VoIP call. Similarly, SIP 302 is an exemplary SIP response message, transmitted to indicate that a SIP request message has been successfully received and authenticated. Moreover, SIP 407 Proxy Authentication Required is a SIP response message, transmitted to authenticate a device with a local proxy server.

A SIP 407 Proxy Authentication Required prompts a destination device to return authentication and authorization credentials (e.g. a username/password combination). Returned authentication/authorization credentials are traditionally encrypted, to avoid exposing sensitive data, in the event VoIP packets are intercepted during network transmission.

Credentials supplied in response to a SIP 407 Proxy Authentication Required are verified via a proxy authentication function, and thereby deemed either valid or invalid. Results of a SIP challenge are returned to an appropriate VoIP device.

The Session Initiation Protocol (SIP) uses designated network nodes (e.g. proxy servers) to route SIP request and response messages to appropriate destination devices. A Session Border Controller (SBC), for instance, is a network node that routes SIP messages between calling and called parties in a VoIP call. Media content and call signaling information transmitted in a VoIP call are first routed through a Session Border Controller (SBC) interposed between communicating VoIP devices. Prior to forwarding, a Session Border Controller (SBC) may alter received VoIP packets and call signaling information, to mask the identity of an originating/destination VoIP device. Hence, a Session Border Controller (SBC) may modify incoming data packets, to render VoIP devices in a VoIP call, undetectable to external network devices. A Session Border Controller (SBC) may also modify the flow of media content in a VoIP call to provide advanced call management capabilities, e.g., three-way calling, call forwarding, call transfers, etc.

A Diameter protocol is often deployed on networks performing SIP-based Voice over Internet Protocol (VoIP) services. The Diameter protocol provides network authentication and authorization functions.

A Diameter client node requests an authentication/authorization function by encapsulating a Diameter command (i.e. a Diameter command code and flag code) in an IP packet for exchange over an Internet Protocol (IP) network. The Diameter protocol authenticates SIP request and response messages, and authorizes the use of SIP resources used in conjunction with Voice over Internet Protocol (VoIP).

Diameter Media-Auth-Request (MAR) is an exemplary Diameter protocol command. A Diameter client node transmits a Diameter Media-Auth-Request (MAR) to a Diameter server, to request the authentication and authorization of a particular SIP service.

FIG. 5 portrays a conventional transmission of a Diameter Media-Auth-Request (MAR), utilized during VoIP session setup.

As depicted in FIG. 5, an originating device 500 transmits a SIP

INVITE 510 to request a particular destination device 520 partake in a VoIP call. The designated destination device 520 receives the transmitted SIP INVITE 510 and sends a Diameter Media-Auth-Request (MAR) 530 to a Diameter server 540. The Diameter Media-Auth-Request (MAR) 530 prompts the Diameter server 540 to authenticate the originating device 500, and confirm that the originating device 500 has authorization to perform SIP services (e.g. transmit a SIP INVITE 510).

The Diameter server 540 subsequently returns a Diameter Media-Auth-Answer (MAA) 550 to the destination device 520, containing requested authentication and authorization data. If authentication/authorization of the originating device 500 is successful, the destination device 520 may be inclined to engage in the proposed VoIP call.

A Home Subscriber Server (HSS) is queried to assist authentication and authorization functions used in conjunction with Voice over Internet Protocol (VoIP). The Home Subscriber Server (HSS) incorporates a central database containing VoIP subscriber information, e.g., identification criteria, current location, authorization and authentication credentials, service capabilities, security privileges, etc.

Many businesses are beginning to deploy Voice over Internet Protocol (VoIP) communication services, as opposed to traditional telecommunication services. Subscribers transmitting voice communication over a data network via Voice over Internet Protocol (VoIP) are able to fully bypass the traditional telecommunication system, therefore bypassing traditional usage fees, as well. The possibility of accruing lower deployment costs for communication services via Voice over Internet Protocol (VoIP), has provided a fairly powerful incentive for businesses to convert. Moreover, Voice over Internet Protocol (VoIP) permits voice sessions to be seamlessly transferred between a traditional Public Switched Telephone Network (PSTN) and an Internet Protocol (IP) network, thus providing businesses with a robust communication infrastructure.

Unfortunately, VoIP calls are increasingly compromised when a network becomes heavily congested. Transmitted VoIP packets are intended to reach a destination device in real time (i.e. via Real Time Protocol) to permit live communication services. Yet, if a network contains a high volume of traffic, VoIP packets may be either lost or incur too much delay to provide adequate Quality of Service (QoS).

Secure, private networks are optimal for VoIP services. A secure, private network, as opposed to a public network (e.g. the Internet), may contain less congestion and mitigate the security vulnerabilities (e.g. Denial of Service (DoS) attacks, IP packet interception, etc.) that are often present on a public network. Unfortunately, current VoIP networks only provide end point security mechanisms.

A particular device, as opposed to a particular user, may currently register on a VoIP network to gain access to secure network services. Hence, a network security vulnerability is manifested every time an unregistered user gains access to a registered device. Presently, there are no network based security mechanisms that prevent an unregistered user from accessing secure VoIP services via a registered network device.

There is a need for a network based security mechanism that authorizes access to secure Sessions Initiated Protocol (SIP) based services such as voice/video network services (e.g. secure VoIP services) upon attempted usage.

### SUMMARY OF THE INVENTION

In accordance with the principles of the present invention, a method and apparatus that provides network based authorization of secure VoIP services, prompted upon attempted user access, comprises a security broker (SB).

In accordance with the principles of the present invention, a security broker (SB) intercepts a Session Initiated Protocol (SIP) transaction during session setup to transmit a network based security challenge to a (secure) SIP supported application attempting to access VoIP or other services allowed through SIP establishment. The network based security challenge prompts the (secure) SIP application to return proper subscriber authorization/authentication credentials (e.g. a username/password combination) for the services requested in the SIP message.

If credentials returned by the secure SIP application are valid, the security broker (SB) authorizes the network to permit session completion. Alternatively, if credentials returned by the (secure) SIP application are invalid, the security broker (SB) terminates the corresponding session attempt.

In accordance with the principles of the present invention, the security broker (SB) authorizes access to network services on both the origination and termination legs of a Session Initiated Protocol (SIP) transaction such as a VoIP call.

### BRIEF DESCRIPTION OF THE DRAWINGS

Features and advantages of the present invention will become apparent to those skilled in the art from the following description with reference to the drawings, in which:

FIG. 1 portrays an exemplary authorization process performed using a security broker (SB), in accordance with the principles of the present invention.

FIG. 2 depicts an exemplary security broker (SB) authorization procedure performed on the origination leg of a SIP call, in accordance with the principles of the present invention.

FIG. 3 depicts an exemplary security broker (SB) authorization procedure performed on the termination leg of a SIP call, in accordance with the principles of the present invention.

FIG. 4 portrays a conventional transmission of voice information over an Internet Protocol (IP) network using Voice over Internet Protocol (VoIP).

FIG. 5 portrays a conventional transmission of a Diameter Media-Auth-Request (MAR), utilized during SIP session setup.

### DETAILED DESCRIPTION OF ILLUSTRATIVE EMBODIMENTS

The present invention provides a security broker (SB) that prevents an unregistered user from gaining access to IP based services established through Session Initiated Protocol (SIP) or Secure Session Initiated Protocol (SIPS).

In accordance with the principles of the present invention, the inventive security broker (SB) intercepts a Session Initiated Protocol (SIP/S) transacation during session setup, to transmit a network based security challenge to a (secure) SIP application on a an originating/destination device. The network based security challenge prompts the (secure) SIP application, e.g., on a calling party's originating device, to return proper authorization/authentication credentials. The Authorization/authentication credentials may be supplied via the user, through an application menu in real-time, or stored on the application from previous configuration. In addition, the authorization/authentication credentials may be separate and distinct from any other credentials used to perform SIP services registration. Authorization/authentication credentials supplied in response to the network based security challenge, must be validated by the security broker (SB) before access to secure network services is permitted.

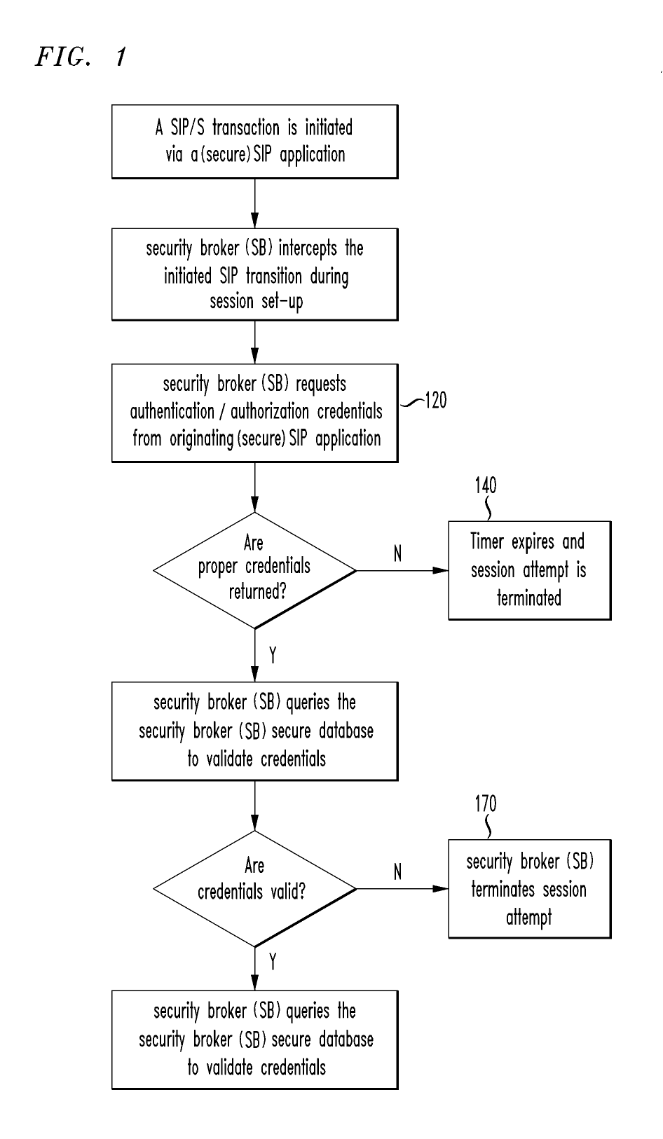

FIG. 1 portrays an exemplary authorization process performed using a security broker (SB), in accordance with the principles of the present invention.

As depicted in step 100, an end user initiates a IP based service, in this example a VoIP service, via a (secure) SIP application on a registered network device (e.g. via an application menu on a registered mobile phone).

As shown in step 110, the inventive security broker (SB) subsequently captures session initiation messages transmitted to set up the VoIP call initiated in step 100, thereby intercepting VoIP session setup.

As depicted in step 120, the security broker (SB) holds the intercepted SIP/S session and transmits a network based security challenge to the (secure) SIPS application on the originating device. The network based security challenge prompts the (secure) SIP application to provide subscriber authorization/authentication credentials (e.g. a username/password combination).

As portrayed in step 130, if the (secure) SIP application returns requested authorization/authentication credentials, the security broker (SB) queries a security broker (SB) secure database or applicable database service to verify the validity of credentials returned (step 150).

As shown in step 160, if returned credentials are invalid, the security broker (SB) terminates the current session attempt (step 170), preventing unauthorized access to the SIP requested services.

Otherwise, if returned credentials are valid (step 160), the security broker (SB) authorizes the network to permit session completion (step 180), and the (secure) SIP application on the originating device is granted access to the requested IP based service e.g. secure VoIP services. An identical authorization process is may then be performed on the secure SIP application residing on the call destination device. The inventive security broker (SB) can be configured to authenticate/authorize origination and destination or individually based upon the SIP service or user profile. If the end user on the call destination device is authorized to use the requested IP services, as well, a (secure) service establishment is allowed between the origination and destination applications.

As portrayed in step 140, if a user alternatively fails to return authorization/authentication credentials (step 130) a timer within the security broker (SB) expires and the current session attempt is terminated.

In accordance with the principles of the present invention, the security broker (SB) challenges access to IP services initiated via SIP/S on both the origination and termination legs of a SIP transaction.

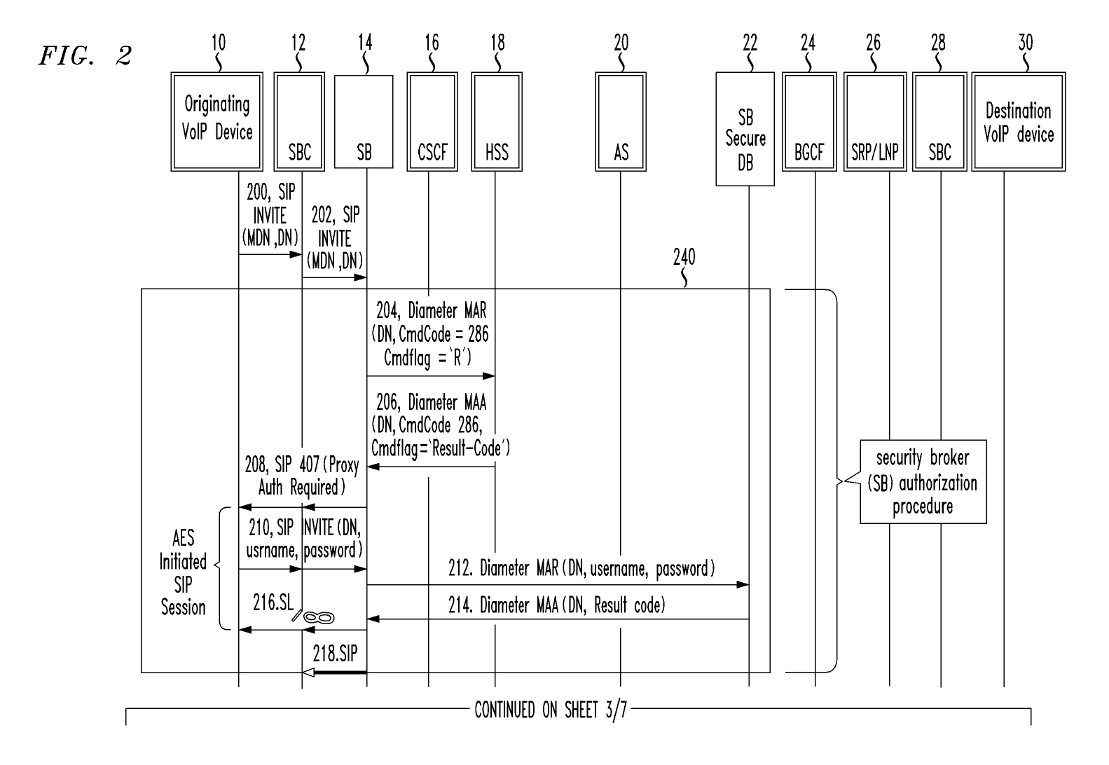

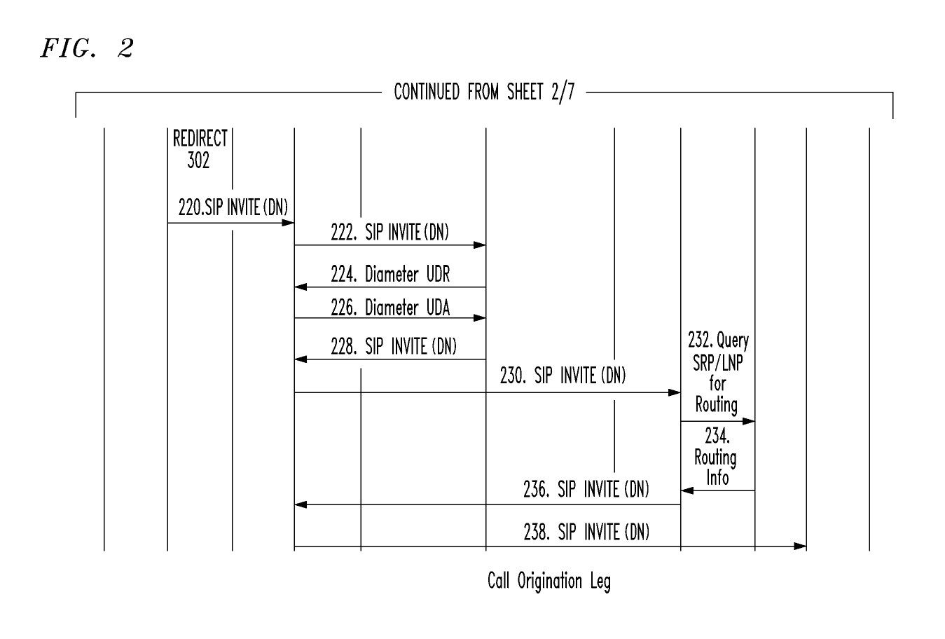

FIG. 2 depicts an exemplary security broker (SB) authorization procedure performed on the origination leg of a SIP transaction, in accordance with the principles of the present invention.

Only those conventional network nodes that are necessary to explain the principles of the present invention are portrayed in FIG. 2. As depicted in FIG. 2, the present invention utilizes an originating device 10 comprising a (secure) SIP application which enables an IP service e.g. a VoIP application, an originating session border controller (SBC) 12, an inventive security broker (SB) 14, a call session control function (CSCF) 16, a home subscriber server (HSS) or SIP Registrar 18, an application server (AS) 20, an invention security broker (SB) secure database 22, a breakout gateway control function (BGCF) 24, a server router protocol (SRP) database and/or a local number portability (LNP) database 26, a terminating session border controller (SBC) 28, and a destination device 30 comprising a (secure) SIP application which enables an IP service e.g. a VoIP application.

In step 200, a calling party initiates a VoIP call with a particular destination device 30, using a (secure) SIP enabled application on an originating network device 10. To initiate session setup, the calling party's originating device 10 transmits a SIP INVITE to the originating session border controller (SBC) 12 that is acting as a proxy server between communicating VoIP devices. A SIP INVITE is transmitted by an originating device 10 to invite a destination device 30 to partake in a VoIP call.

In step 202, the originating session border controller (SBC) 12 receives the transmitted SIP INVITE and retrieves the mobile directory number (MDN) affiliated with the calling party's originating device 10. The originating session border controller (SBC) 12 (optional) subsequently queries an appropriate database to determine IP capabilities associated with the attained mobile directory number (MDN). In doing so, the originating session border controller (SBC) 12 discovers that the originating mobile directory number (MDN) attributes to a device 10 with security and second authorization privileges. Upon discovery, the originating session border controller (SBC) 12 triggers a security broker (SB) authorization procedure 240, by forwarding the received SIP INVITE to the inventive security broker (SB) 14 to carry out appropriate security and second authorization procedures. Second authentication requires authentication/authorization credentials separate from those credentials required during an initial or periodic SIP/S registration process. Second authentication only occurs when an IP service request is made through a SIP/S INVITE transaction.

In step 204, the security broker (SB) 14 receives the forwarded SIP INVITE and retrieves the mobile directory number (MDN) affiliated with the calling party's originating device 10. The security broker (SB) 14 ensuingly transmits a diameter media-auth-request (MAR) to a home subscriber server (HSS) or Diameter Server if appropriate 18 to ensure that the subscriber profile for the attained mobile directory number (MDN) also indicates security and second authorization privileges.

In step 206, the home subscriber server (HSS)/Diameter Server 18 receives the transmitted diameter media-auth-request (MAR) and uses the subscriber profile stored for the supplied mobile directory number (MDN) to determine if the originating device 10 is entitled to security and second authorization privileges.

If the home subscriber server (HSS)/Diameter Server 18 determines that the originating device 10 is not entitled to security and second authorization privileges, a diameter media-auth-answer (MAA) indicating a failed authorization/authentication attempt is returned to the security broker (SB) 14. The security broker (SB) 14 consequently terminates the corresponding session attempt upon receipt of the diameter media-auth-answer (MAA) (not shown).

Otherwise, if verification of security and second authorization privileges for the originating device is successful (step 206), the home subscriber server (HSS) 18 returns a diameter media-auth-answer (MAA) to the security broker (SB) 14 indicating the successful validation.

In step 208, the security broker (SB) 14 receives the diameter media-auth-answer (MAA) confirming privileges to security and second authorization capabilities on the calling party's originating device 10. Upon receipt, the security broker (SB) 14 transmits an advanced encryption standard (AES) 407 SIP/S proxy authentication required to the secure SIP application on the originating device 10 if the SIP Invite received was a SIPS transaction. Otherwise, the security broker (SB) 14 transmits an unencrypted 407 SIP Proxy authentication required to the SIP application on the originating device 10. The 407 SIP proxy authentication required prompts the (secure) SIP application to transmit a response containing subscriber authentication and authorization credentials (e.g. a username/password combination).

In step 210, the (secure) SIP application on the originating device 10 receives and validates the 407 SIP proxy authentication required. The (secure) SIP application then properly responds with an advanced encryption standard (AES) SIPS INVITE, containing requested authorization and authentication credentials. Authorization and authentication credentials preferably include the directory number (DN) of the originating device 10 on which secure VoIP services are being activated, as well as a username/password combination identifying a permitted user attempting to access service.

In step 212, the security broker (SB) 14 receives the advanced encryption standard (AES) SIPS INVITE and retrieves requested authorization and authentication credentials and verifies that a SIPS transaction was received. The security broker (SB) 14 subsequently transmits a secure diameter media-auth-request (MAR) to a security broker (SB) secure database 22 to validate the second authentication credentials retrieved from the advanced encryption standard (AES) SIPS INVITE.

In step 214, a diameter service on the security broker (SB) secure database 22 receives the diameter media-auth-request (MAR) containing supplied user credentials. Upon receipt, the security broker (SB) secure database 22 compares credentials supplied against credentials stored for a subscriber registered to access secure VoIP services on the originating device 10.

If supplied credentials are not valid, the diameter service on the security broker (SB) secure database 22 returns a diameter media-auth-answer (MAA) to the security broker (SB) 14, to identify the failed authorization/authentication attempt. Upon receipt, the security broker (SB) 14 consequently terminates the current session attempt (not shown) via the session border controller (SBC) 28.

Alternatively, if supplied credentials are valid, the diameter service on the security broker (SB) secure database 22 transmits a diameter media-auth-answer (MAA) to the security broker (SB) 14, to indicate successful validation (step 214).

In step 216, the security broker (SB) 14 receives the diameter media-auth-answer (MAA) indicating successful validation of authorization/authentication credentials. Upon receipt, the security broker (SB) 14 transmits a SIPS 100 TRYING to the secure SIP application residing on the calling party's originating device 10. The SIPS 302 indicates that the SIP INVITE transmitted to initiate the IP service in step 100, has been successfully received and authenticated.

In step 218, the security broker (SB) 14 transmits a SIP/S, depending upon SBC capability, redirect 302 moved temporarily to the originating session border controller (SBC) 12, prompting session completion to be carried out on the call origination leg (i.e. steps 220-242), via conventional session control procedures.

Once the origination leg of the VoIP call initiated in step 100 has completed (step 238), the security broker (SB) authorization procedure 240 is subsequently performed on the termination leg of the corresponding SIP transaction, if the call destination device is also entitled to security and second authorization privileges.

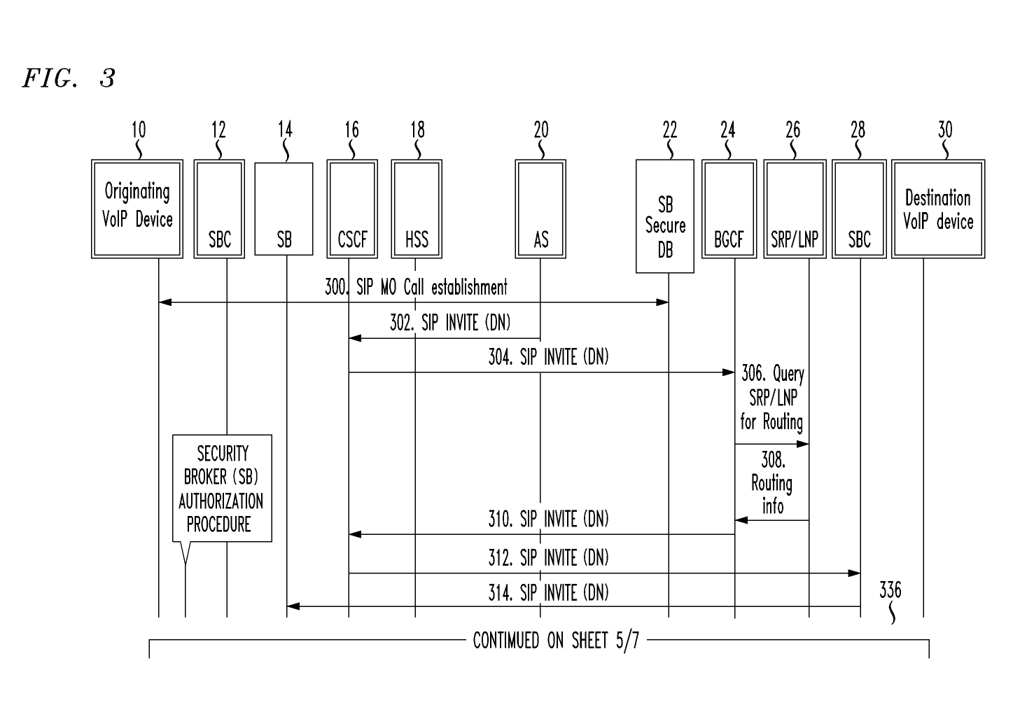

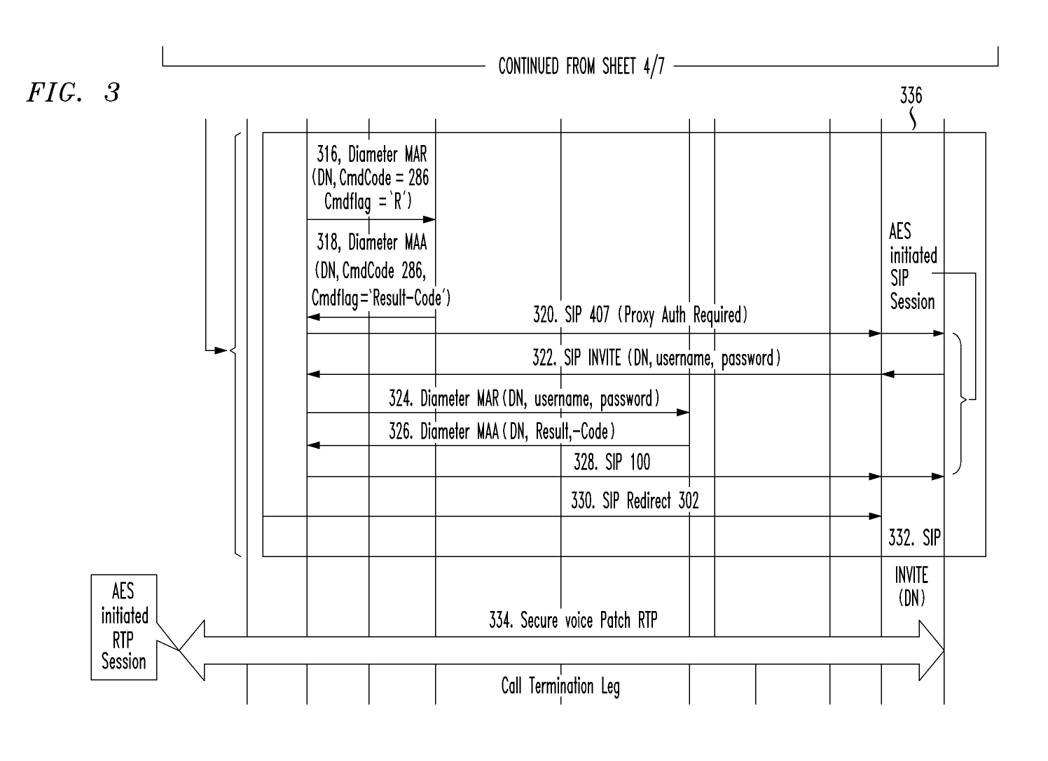

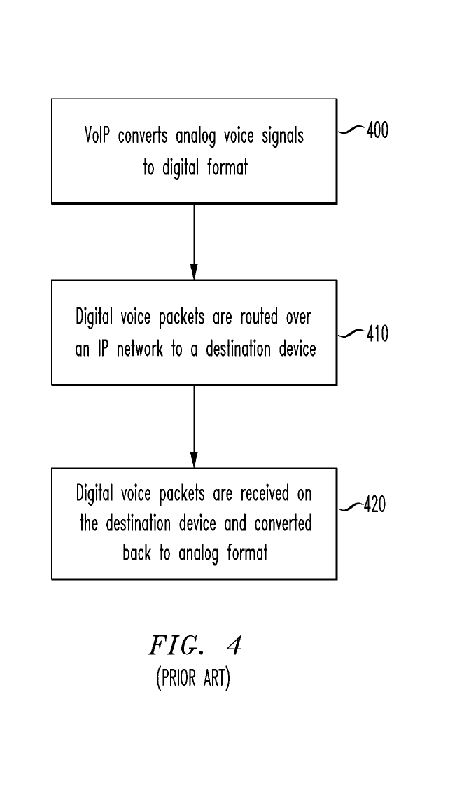

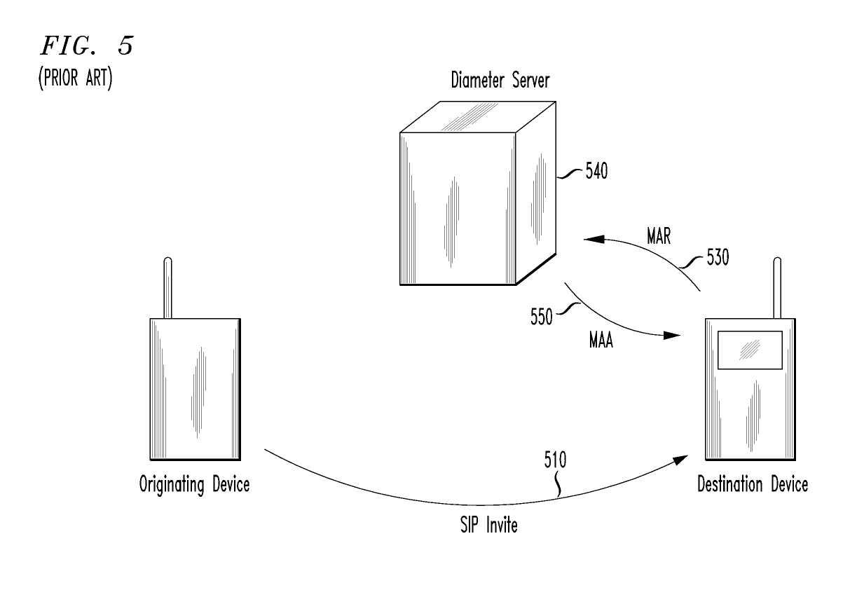

FIG. 3 depicts an exemplary security broker (SB) authorization procedure performed on the termination leg of a IP transaction, in accordance with the principles of the present invention.

As depicted in step 312, a SIP INVITE is transmitted to a terminating session border controller 28 to invite a designated destination device 30 to partake in an initiated VoIP call.

In step 314, the terminating session border controller (SBC) 28 receives the transmitted SIP INVITE and retrieves the mobile directory number (MDN) affiliated with the designated destination device 30. The terminating session border controller (SBC) 28 subsequently queries an appropriate database to determine VoIP capabilities associated with the attained mobile directory number (MDN). In doing so, the terminating session border controller (SBC) 28 discovers that the mobile directory number (MDN) affiliated with the destination device 30 attributes to a device 30 with security and second authorization privileges. Upon discovery, the terminating session border controller (SBC) 28 triggers the inventive security broker (SB) authorization procedure 336, by forwarding the received SIP INVITE to the security broker (SB) 14 to carry out appropriate security and second authorization procedures.

The security broker (SB) authorization procedure 336 is subsequently performed on the termination leg of the initiated VoIP call (steps 316-330) in the same manner in which the security broker authorization procedure 240 was carried out in the call origination leg (steps 204-218). The security broker authorization procedure 336 authorizes a IP services application on the call destination device to access secure IP services, in the same manner that the security broker authorization procedure 240 authorized a IP application on a calling party's originating device to access secure IP services.

A secure services path is established in an initiated e.g. VoIP call (step 334) once call originating and destination VoIP applications are both authorized to use secure IP services.

The present invention is applicable to various voice/video network services, being that the inventive security broker (SB) authorization procedure described herein is based upon session management protocols that are widely deployable for other services.

While the invention has been described with reference to the exemplary embodiments thereof, those skilled in the art will be able to make various modifications to the described embodiments of the invention without departing from the true spirit and scope of the invention.

What is claimed is:

1. A security broker to authorize use of a secure IP service, comprising:
intercepting a Session Initiation Protocol (SIP) or Secure Session Initiated Protocol (SIPS) transaction during session setup;
transmitting a network based security challenge to a secure SIP device attempting to access a IP service associated with said SIP transaction;
prompting said secure SIP application to return an authorized subscriber authentication credential in only SIPS format;
forcing a SIP client to switch between Session Initiation Protocol (SIP) to Secure Session Initiated Protocol (SIPS) transaction;
receiving a returned subscriber authentication credential in response to said prompting using SIPS when previous transaction was in SIP format; and
switching a SIPS transaction back to SIP if appropriate for the remainder of a SIP transaction. authorizing an associated network to permit completion of an associated SIP session if said returned subscriber authentication credential is valid.

2. The security broker to authorize use of a secure IP service in accordance with claim 1, wherein said subscriber authorization/authentication credential, separate credential from SIP/S registration process, comprises:
a username and password combination
b and/or a personal identification number
c and/or biometric information.

3. The security broker to authorize use of a IP service in accordance with claim 1, wherein:
said security broker authorizes access to said IP network service on both an origination leg and a termination leg of said SIP transaction.

4. Apparatus to authorize use of a secure IP service, comprising:
means for intercepting a Session Initiation Protocol (SIP) or Secure Session Initiated Protocol (SIPS) transaction during session setup;
means for transmitting a network based security challenge to a secure SIP device attempting to access a IP based service associated with said IP call;
means for prompting said secure SIP application to return an authorized subscriber authentication credential in only SIPS format;
means for forcing a SIP client to switch between Session Initiation Protocol (SIP) to Secure Session Initiated Protocol (SIPS) transaction;
means for receiving a returned subscriber authentication credential in response to said prompting; and
means for switching a SIPS transaction back to SIP if appropriate for the remainder of a SIP transaction.
means for authorizing an associated network to permit completion of an associated SIP session if said returned subscriber authentication credential is valid.

5. The apparatus to authorize use of a secure IP service in accordance with claim 4, wherein said subscriber authorization/authentication credential, separate credential from SIP/S registration process, comprises:
a username and password combination
b and/or a personal identification number
c and/or biometric information.

6. The apparatus to authorize use of a IP service in accordance with claim 4, wherein:
said security broker authorizes access to said IP network service on both an origination leg and a termination leg of said IP call.
